(19) United States
(12) Patent Application Publication
(10) Pub. No.: US 2008/0181759 A1
(43) Pub. Date: Jul. 31, 2008

(54) WORKPIECE HANDLING DEVICE

(76) Inventors: Alfred GAEGAUF, Wattenwil (CH); Philipp WENGER, Winterthur (CH)

Correspondence Address: OSTROLENK FABER GERB & SOFFEN, 1180 AVENUE OF THE AMERICAS, NEW YORK, NY, 100368403, US

(21) Appl. No.: 11/966,002

(22) Filed: Dec. 28, 2007

(30) Foreign Application Priority Data
Jan. 30, 2007 (CH) 00152/07

(51) Int. Cl. B65G 65/02

(52) U.S. Cl. 414/751.1

(57) ABSTRACT

The workpiece handling device comprises a cantilever (1) that is movable in a movement direction (Y), a carriage (11) that is arranged on the cantilever and movable with respect to the cantilever in the movement direction, and a gripper (15; 25) that is arranged on the carriage and movable transversally (Z) to the movement direction.

### FIELD OF THE INVENTION

The present invention relates to a workpiece handling device and to an arrangement of a machine tool and of a workpiece handling device.

### BACKGROUND OF THE INVENTION

For a rational machining, workpiece handling devices (also called handling devices hereinafter) are used. These devices serve for the automatic supply of workpieces to the processing station and for their removal after the machining operation.

In situations of limited space in the machine tool, an automatic workpiece exchange is difficult. Thus, for example, grinding machines having a very low construction height are known in the art. Loading and unloading can be achieved by means of an usual handling device in the form of a robot or loader from the front side or the top (see e.g. the documents DE 32 05 547 A1 and DE 44 43 467 C1, both of which disclose a handling device for a workpiece exchange from the top). However, loading and unloading from the front side or from the top entails considerable disadvantages:
The work station is no longer accessible for the user, so that setting up the machine tool as well as a possible manual workpiece exchange are more difficult.
If loading is performed from the front side, the user cannot see the work station and thus the workpiece during the machining process. However, this is often required for optimum machining.
A system for automatically opening and closing the operator doors of the machine tool has to be provided. This causes additional costs and longer workpiece exchange times.
The handling device is liable to carry along material that is produced in the machining operation. To counteract this, additional costly measures are required.

In EP 0 721 821 A2 it is suggested to provide a workpiece handling device that is arranged adjacent to the machine tool an has a movable swinging arm which enters into the machine tool laterally. The arm is movably arranged on a gantry extending above the station where the workpieces are supplied. This design of the handling device leads to a relatively voluminous construction. In addition, the control of the swinging arm is relatively complicated. For example, if a workpiece is exchanged at the work station, it is generally moved in the vertical direction. Such a movement requires that the swinging arm is both pivoted and moved. This is not possible with simple control systems.

### SUMMARY OF THE INVENTION

On the background of this prior art, it is an object of the present invention to provide a workpiece handling device having a simpler and more compact construction.

This object is achieved by a workpiece handling device comprising a cantilever that is movable in a movement direction, a carriage that is arranged on the cantilever and movable with respect to the cantilever in the movement direction, and a gripper that is arranged on the carriage and movable transversally to the movement direction.

The workpiece handling device according to the invention has a simpler and more compact construction.

### BRIEF DESCRIPTION OF THE DRAWINGS

The invention will be explained hereinafter by means of exemplary embodiments and with reference to figures, where

FIG. 1 shows a first exemplary embodiment of an arrangement of a handling device according to the invention and of a machine tool in a front view;

FIG. 2 shows a part of the arrangement according to FIG. 1 in a lateral view; and

FIG. 3 shows a second exemplary embodiment of an arrangement of a handling device according to the invention and of a machine tool in a front view.

### DETAILED DESCRIPTION OF THE PREFERRED EMBODIMENTS

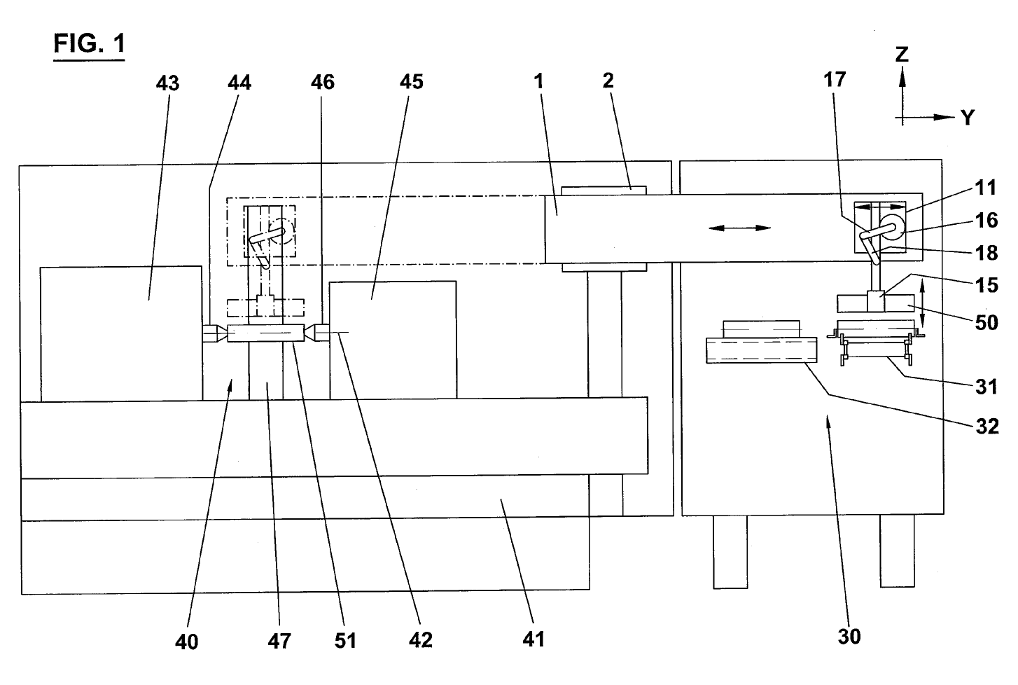

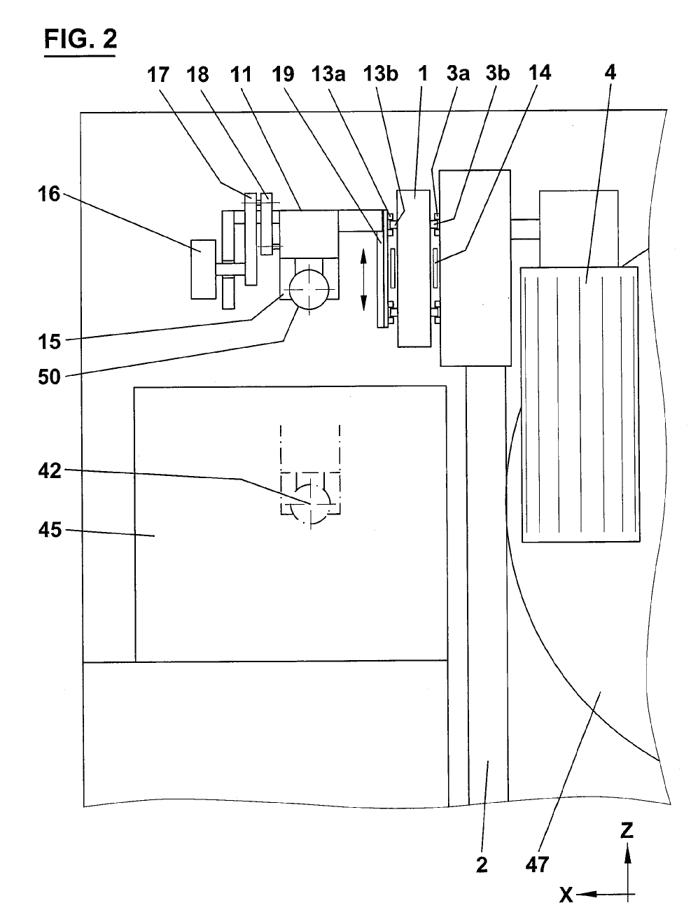

As seen in FIGS. 1 and 2, the handling device comprises a cantilever 1 that is movable in the horizontal direction. According to FIG. 1, this movement direction corresponds to the Y direction. Cantilever 1 has the shape of a plate and is fastened to a support 2 in the form of a post. The latter is fastened to machine bed 41 of the machine tool. Alternatively, it is conceivable to support post 2 on a lateral wall of the machine tool or outside the same on the ground.

For guiding cantilever 1, support 2 is provided with guide rails 3a along which guide shoes 3b of cantilever 1 are slidable. Support 2 and thus guides 3a are shorter than cantilever 1. A drive 4 having a pinion is affixed to support 2 and engages in a toothed rack formed on cantilever 1. (The pinion and the toothed rack are not shown in the Figures). Drive 4 is in the form of an electric drive and is controllable by a suitable control, e.g. a CNC control.

On cantilever 1, a carriage 11 is arranged that is movable in the Y direction too. For its guidance, carriage 11 is provided with guide rails 13a sliding on guide shoes 13b of cantilever 1. Cantilever 1 is provided with a toothed belt 14 that is coupled to drive 4 and to carriage 11. Cantilever 1 and carriage 11 are thus forcibly coupled to one another. Instead of a toothed belt 14, other means for a forced coupling are also suitable, e.g. a chain.

In operation, drive 4 drives the pinion, thereby moving the toothed rack and thus cantilever 1 in the movement direction. Simultaneously, drive 4 drives toothed belt 14, whereby carriage 11 is moved with respect to cantilever 1 in the same movement direction. Cantilever 1 and carriage 11 are thus moved telescopically.

Carriage 11 is provided with a gripper 15 that is movable in the vertical direction, i.e. in the Z direction, and serves for receiving and holding a workpiece 50.

The vertical movement of gripper 15 is achieved by a crank drive as it is shown in more detail in FIG. 2. A rotary drive 16 provided with a rotary arm 17 is fastened to carriage 11. Rotary arm 17 is rigidly connected to the rotary shaft of rotary drive 16.

As a rotary drive 16, e.g. a pneumatic drive is suitable by means of which rotary arm 17 can be swivelled between a first position and a second position. It is also possible to use an electric drive for rotary drive 16.

On one side, gripper 15 is guided by a linear guide 19 that extends in the Z direction and is e.g. in the form of a sliding guide. On the opposite side, gripper 15 is coupled to rotary arm 17 by a coupling bar 18. The two ends of coupling bar 18 are hinged to rotary arm 17 and to gripper 15, respectively. Consequently, rotary arm 17 and coupling bar 18 form rigid axles that are hinged to one another and by means of which gripper 15 is coupled to rotary drive 16. Gripper 15 is provided with yet another drive (not shown) e.g. of the pneumatic type and serves for opening and closing the jaws of gripper 15.

When rotary arm 17 is in its first position, gripper 15 is in its retracted end position as shown in FIG. 2. When rotary drive 16 is actuated, rotary arm 17 is swivelled to its second position, whereby gripper 15 is pushed downwards by coupling bar 18 so as to reach its extended end position as it is shown in FIG. 2 by the dash dotted lines. Linear guide 19 ensures that gripper 15 is moved on a linear path of motion.

The utilization of rotary drive 16 offers the advantage that during the rotation motion of rotary arm 17, the vertical position of gripper 15 varies sinusoidally in time. Consequently, gripper 15 is decelerated and accelerated not with a jerk, but in a gentle manner. It is thereby ensured, inter alia, that gripper 15 firmly maintains a workpiece also in the starting movement while the latter is being picked up from its rest position. In spite of a movement without jerk, the sinusoidal movement ensures a rapid lowering and lifting of a workpiece and thereby keeps the workpiece exchange time short.

As seen in FIG. 1, the handling device is arranged such that workpieces can be transported back and forth between a supply station 30 and a work station 40. As illustrated by the dash dotted lines in FIG. 1, cantilever 1 is movably arranged on support 2 in such a manner that it may project over the end of support 2 on the side of work station 40. Cantilever 1 is also movable in such a manner as to project over the end of support 2 on the side of supply station 30.

Supply station 30 comprises a loader 31 for loading the workpieces that are to be machined (unmachined parts) and a unloader 32 for unloading the machined workpieces (finished parts). Supply station 30 is e.g. part of a supply module that the machine tool can be retrofitted with. Alternatively, it may be directly integrated into the machine tool.

The two devices 31 and 32 are arranged side by side and adjustable in height. The latter is chosen such that the workpiece axis of the workpieces placed on devices 31 and 32 is located at the same level as machining axis 42 of the machine tool. This allows operating gripper 15 with a fixed, predetermined vertical stroke in order to pick up and deliver workpieces. As a loader 31, e.g. a sequencer is suitable, and as an unloader 32, a conveying belt. It is also possible to load and unload the workpieces by means of pallets.

The machine tool comprises a work station 40 where the workpieces are machined. In the exemplary embodiment shown here, the machine tool is in the form of a grinding machine. For rotary machining, a workpiece 51 is rotated about machining axis 42. For this purpose, the grinding machine comprises a workpiece spindle headstock 43 including a center point 44, a tailstock 45 being movable in the Y direction and having a tailstock center 46, and a grinding wheel 47 that is movable in the X and Y directions.

For protection, both the machine tool and the supply station are provided with protective covers (not shown).

A possible sequence of operations in the workpiece exchange is as follows:

While a workpiece 51 is being machined at work station 40, gripper 15 is located in a waiting position e.g. above tailstock 45. When machining is completed, cantilever 1 and therewith also carriage 11 are moved in the negative Y direction until gripper 15 is located above workpiece 51. By actuating rotary drive 16, gripper 15 is lowered and then workpiece 51 is seized. Tailstock 42 releases workpiece 51, and the latter is raised together with gripper 15. (In FIG. 1, the position of carriage 11 and cantilever 1 while gripper 15 is being raised is illustrated by the dash dotted lines). Carriage 11 is moved in the positive Y direction until workpiece 51 is located above unloader 32. Workpiece 51 is laid down, and carriage 11 is then further moved in the positive Y direction until gripper 15 is located above loader 31. The next workpiece 50 that is to be machined is picked up by gripper 15 and transported to work station 40.

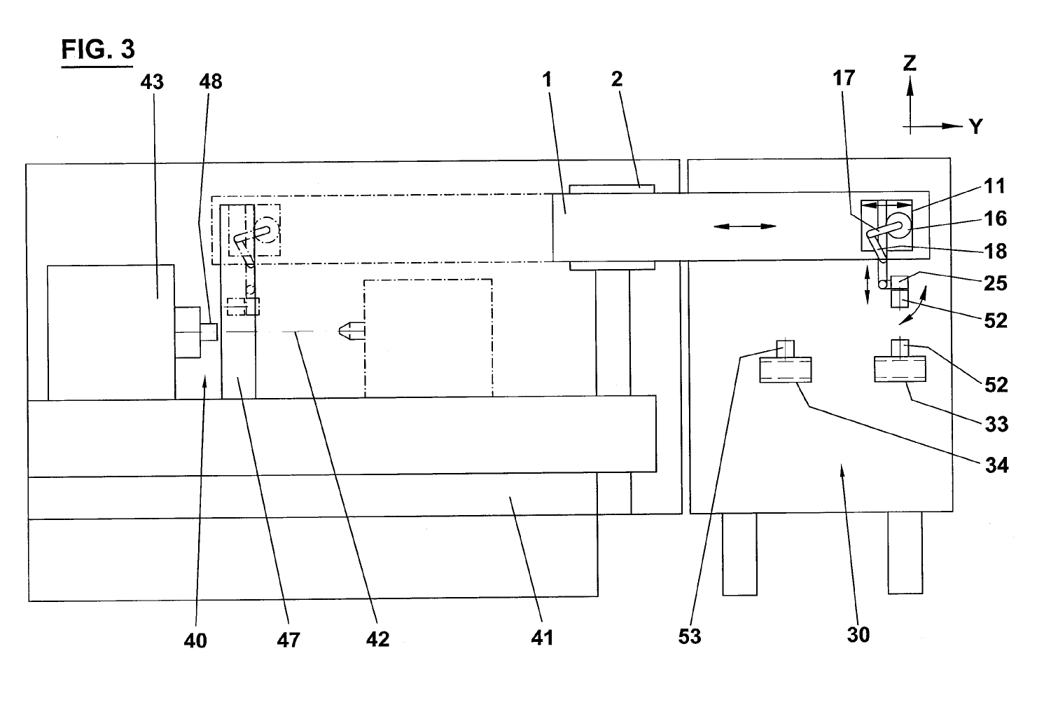

The machine tool shown in FIGS. 1 and 2 serves for machining workpieces in the form of shaft parts. FIG. 3 shows another machine tool that is suitable for machining workpieces in the form of chuck parts 52 and where identical elements are designated by the same reference numerals. Workpiece spindle headstock 43 comprises a chuck 48 for clamping a workpiece. Workpieces 52 and 53 are positioned on loader 33 and unloader 34 in such a manner that the axis of rotation of workpieces 52, 53 is aligned in the Z direction and thus perpendicular to machining axis 42 in at work station 40. For the manipulation of workpieces 52, 53, gripper 25 is provided with a pivoting gripper head. Pivoting is achieved by a pneumatic drive (not shown). In the exemplary embodiment shown here, gripper head is pivotable by 90 degrees.

Loader 33 and unloader 34 are each in the form of conveying belts that are adjustable in height. This allows the height of loader 33 and unloader 34 to be adapted to the corresponding length of the workpieces that are to be machined such that the vertical stroke of gripper 25, over which the latter is moved during actuation of rotary drive 16, need not be varied at the two stations 30 and 40.

Optionally, the handling device may be designed so that gripper 25 or gripper 15 may selectively be mounted on carriage 11. It is thus possible in a simple manner to set up the handling device for the manipulation of either shaft parts 50 or chuck parts 52.

As far as they are not yet mentioned, the described conception of the handling device offers the following advantages:

The handling device is designed so that loading and unloading of the machine tool can be achieved laterally, i.e. the movement direction of cantilever 1 is essentially parallel to machining axis 42. Access from the front side and the view on work station 40 are therefore unhindered. Moreover, the handling device is located outside the working area during the machining process. This prevents that material produced during machining, e.g. in the form of chips, cooling lubricant or the same, is carried along. If work station 40 is protected by usual sliding doors, these need not be automatic.

As seen particularly in FIG. 2, the handling device has a compact construction. It is therefore also suitable for loading machine tools having a low construction height. Thus, for example, grinding machines can be laterally loaded where the free space between tailstock 45 and the uppermost edge of the machine is smaller than 600 mm or even smaller than 300 mm. The compact design of the handling device also allows retrofitting an already existing machine tool that is only designed for manual workpiece exchange in such manner that an automatic workpiece exchange is also possible.

Typically, the handling device allows a precise transport of workpieces having a diameter of up to 100 mm and a weight of up to 5 kg back and forth between the stations while the positioning accuracies are comprised within a range of ±0.1 mm.

The kinematics are simple: Cantilever 1 and carriage 11 are each moved in a linear direction by drive 4, and so is gripper 15, 25 by rotary drive 16 and linear guide 19. The control of the handling device is therefore simple.

The movements of gripper 15, 25 can be produced solely by the actuation of pneumatic drives. In this case, no electric conductors leading to carriage 11 via support 2 and cantilever 1 are required.

From the preceding description, numerous modifications are accessible to one skilled in the art without leaving the protective scope of the invention that is defined by the claims.

The handling device is utilizable for loading and unloading various kinds of machine tools, particularly of the type used for rotary machining of a workpiece such as circular grinding or turning.

The handling device need not necessarily be oriented as shown in the Figures. The movement direction of cantilever 1 or carriage 11, respectively, can be adapted to the particular application.

The gripper may be designed as required in order to be able to seize and hold one or a plurality of workpieces. Thus, e.g. mechanical, pneumatic or magnetic grippers are suitable.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A workpiece handling device, comprising
a cantilever that is movable in a movement direction,
a carriage that is arranged on said cantilever and movable with respect to said cantilever in said movement direction, and
a gripper that is arranged on said carriage and movable transversally to said movement direction.

2. The handling device according to claim 1, wherein a rotary drive for moving said gripper is arranged on said carriage.

3. The handling device according to claim 2, wherein said rotary drive is actuatable pneumatically.

4. The handling device according to claim 2, wherein said gripper is coupled to said rotary drive by means of mechanical axles.

5. The handling device according to claim 1, wherein said carriage is provided with a linear guide for guiding said gripper.

6. The handling device according to claim 1, wherein said gripper is pivotable for handling chuck parts.

7. The handling device according to claim 1, wherein said cantilever and said carriage are coupled to the same drive in order to produce a simultaneous movement of said cantilever and said carriage.

8. The handling device according to claim 1, wherein said movement direction of said cantilever is oriented in a substantially horizontal direction and said gripper is movable in a substantially vertical direction.

9. An arrangement of a machine tool and a handling device according to claim 1, comprising a first station for keeping workpieces and a second station for machining said workpieces, said handling device being arranged such that said gripper is movable between said first and said second station.

10. The arrangement according to claim 9, wherein the machining axis about which a workpiece is machinable at said second station is arranged substantially parallel to said movement direction of said cantilever.

11. The arrangement according to claim 9, wherein for loading and unloading said workpieces said first station has two conveying devices.

12. The arrangement according to claim 11, wherein said two conveying devices are arranged side by side.

13. The arrangement according to claim 9, wherein said machine tool has at least one of the following components:
a workpiece spindle headstock,
a tailstock,
a grinding wheel.
